(19) United States
(12) Patent Application Publication
(10) Pub. No.: US 2011/0163050 A1
(43) Pub. Date: Jul. 7, 2011

(54) Floor and wall-mounted stands with backlighting

(76) Inventor: James E. Grove, Marina Del Rey, CA (US)

(21) Appl. No.: 12/655,570

(22) Filed: Jan. 4, 2010

(51) Int. Cl. A47F 7/00; A47F 5/00; F21V 3/00

(52) U.S. Cl. 211/26; 211/134; 362/311.01; 362/311.02

(57) ABSTRACT

Backlighted floor and wall-mounted stands, each including a set of shelves and a mood-enhancing light source (e.g., an LED tube) located behind the shelves. According to one preferred embodiment, the stand has a base that is seated on the floor and a pair of upstanding TV mount support posts connected to the base to hold a television above the shelves. A set of flexible light-diffusing panels are bent around and in front of the light source so as to be removably retained between the TV mount support posts. According to a second preferred embodiment, the stand has a pair of vertical V-shaped side rails that are held by back braces against a wall. A set of flexible light diffusing panels are bent around and in front of the light source so as to be removably retained between the V-shaped side rails.

### BACKGROUND OF THE INVENTION

1. Field of the Invention

This invention relates to floor and wall-mounted stands, each having a set of shelves and a source of mood-enhancing light located behind the shelves and covered by a removable light diffuser. In one embodiment, the floor-mounted stand is adapted to support a television above the shelves.

2. Background Art

Shelving is widely used around a home or office for a variety of purposes. For example, books, electronic audio and video devices, decorative curios, and the like, have been seated on one or more of the shelves. In many instances, there will be insufficient room light to illuminate the items located on the shelves. In some cases where it is otherwise known to use a dedicated light source with a set of shelves, the light generated by the source is often confined to a single shelf. In other cases, the light generated by the source can be undesirably bright and intrusive, especially in situations where a low light level is desirable to create a relaxing mood. What is more, the light source is commonly visible to occupants of a room which may negatively impact the room decor.

Therefore, it would be desirable to have a set of shelves with a source of backlighting to illuminate all the shelves and create a mood-enhancing effect while the light source remains out of sight.

### SUMMARY OF THE INVENTION

According to a first preferred embodiment, a backlighted floor-mounted stand is disclosed including a base that is seated on the floor. A pair of shelf support posts which stand upwardly from the front of the base hold a pair of shelves in spaced, parallel alignment one above the other. A pair of TV mount support posts which stand upwardly from the rear of the base extend past the shelves to be connected to and hold a commercially-available TV mount. A back panel is secured between the pair of TV mount support posts. A light source (e.g., an LED tube) is detachably connected to the back panel so as to be capable of illuminating the base and each of the shelves spaced above the base. A set of flexible light-diffusing panels are bent around the light source and removably held in place between the TV mount support posts so as to lie in front of the back panel. The light-diffusing panels hide the light source from view but enable a mood-enhancing backlighting effect to be created. Wire access openings are formed at the corners of each light-diffusing panel to enable electrical wires and cables to remain out of sight and they are connected to audio and video equipment seated on the shelves, to a source of power, or to the television supported by the TV mount above the shelves.

According to a second preferred embodiment, a back-lighted wall mounted stand is disclosed including a frame having a pair of vertical V-shaped side rails. Back braces are connected horizontally between the side rails to hold the rails in spaced, parallel alignment with one another. The back braces are connected to a wall, and a set of shelves are supported from the back braces. A light source (e.g., an LED tube) is detachably connected to one or more of the back braces so as to be capable of illuminating the shelves. A set of flexible light-diffusing panels are bent around the light source and removably attached to the V-shaped side rails so as to extend therebetween. The light-diffusing panels hide the light source from view but enable a mood enhancing backlighting effect to be created. Wire access openings are formed at the corners of each light-diffusing panel to enable electrical wires and cables to remain out of sight as they are connected to electrical equipment seated on the shelves or to a source of power.

### BRIEF DESCRIPTION OF THE DRAWINGS

FIG. 1 is an exploded view of a floor-mounted stand with backlighting according to a first preferred embodiment of this invention;

FIG. 2 shows the floor-mounted stand of FIG. 1 in the assembled configuration;

FIG. 3 is a cross-section taken along lines 3-3 of FIG. 2;

FIG. 4 is an exploded view of a wall-mounted stand with backlighting according to a second preferred embodiment of this invention; and

FIG. 5 shows the wall-mounted stand of FIG. 4 in the assembled configuration.

### DESCRIPTION OF THE PREFERRED EMBODIMENT

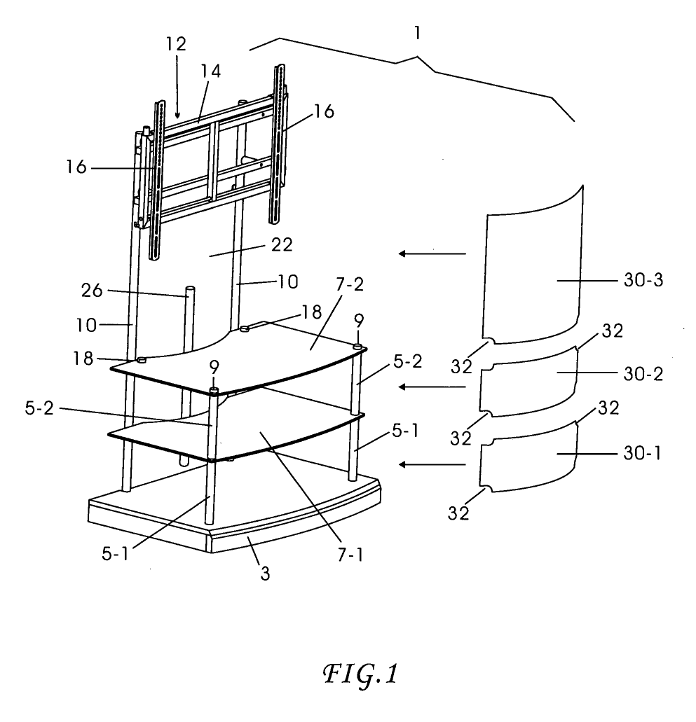

A backlighted, free-standing floor-mounted stand 1 for electronic equipment according to a first preferred embodiment of this invention is disclosed while referring concurrently to FIGS. 1-3 of the drawings. As will be described in greater detail hereinafter, the backlighted stand 1 has particular application for holding a television off the ground at an elevation that is suitable for the watching pleasure of the viewer. As will also be described, the stand is provided with a mood-enhancing, backlighting effect by means of a source of light that remains at an out-of-sight location to provide both ornamental and functional benefits to the viewer.

The backlighted stand 1 includes a generally flat base 3 that is seated on the floor. The base 3 can be manufactured from wood, plastic or any other suitable material. A pair of shelf support posts 5 stand upwardly from the front of the base 3. The backlighted stand 1 includes parallel aligned bottom and top shelves 7-1 and 7-2 that are spaced one above the other. However, it is to be understood that the number of shelves of stand 1 is not to be considered a limitation of this invention. The shelves 7-1 and 7-2 can be manufactured from glass, plastic, wood or any other suitable material.

The front of each shelf 7-1 and 7-2 is held above the base 3 by means of the shelf support posts 5. The posts 5 may run continuously through holes formed in the shelves. Alternatively, each shelf support post 5 may include first and second post sections (designated 5-1 and 5-2 in FIG. 1) that are connected (e.g., screwed together) one above the other. That is, a threaded pin (not shown) which projects from a first post section 5-1 extends through the bottom shelf 7-1 to be mated to a second post section 5-2. A threaded pin (also not shown) which projects from a second post section 5-2 extends through the top shelf 7-2 to be mated to an end cap 9 that is rotated into engagement therewith atop shelf 7-2.

A pair of TV mount support posts 10 stand upwardly from the rear of the base 3. The TV mount support posts 10 are preferably manufactured from metal (e.g., steel) and run continuously between the base 3 and a TV mount 12 located above the shelves. The TV mount 12 is connected to the TV mount support posts 10 of the floor-mounted stand 1 and may be a commercially-available mount which will not be described in detail. Briefly, however, the TV mount 12 includes an open rectangular frame 14 that is adjustably connected to the tops of the pair of support posts 10 above the top shelf 7-2. The TV mount 12 includes a pair of vertically-extending mounting brackets 16 at the front thereof to be connected to the back of a television (not shown), whereby to hold the television off the ground and above the shelves 7-1 and 7-2 of stand 1.

A pair of rigid shelf support arms (not shown) project from respective ones of the TV mount support posts 10 below the top shelf 7-2 to help hold the shelf 7-2 in place in spaced, parallel alignment with the bottom shelf 7-1. Threaded locking pins (also not shown) project upwardly from the shelf support arms through the top shelf 7-2. End caps 18 are rotated into mating engagement with the locking pins atop the shelf 7-2. Another pair of shelf support arms (not shown) project from the TV mount support posts 10 so as to lie below and provide support for the bottom shelf 7-1.

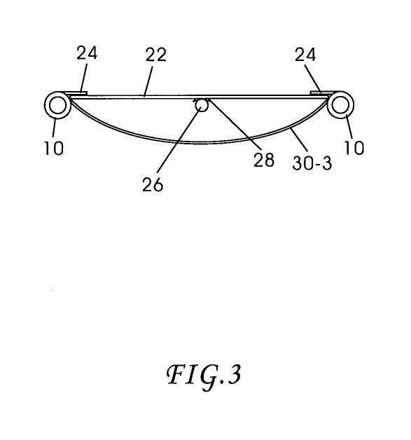

A vertically-extending back panel 22 (best shown in FIG. 3) is secured between the TV mount support posts 10 of the backlighted floor-mounted stand 1 from the base 3 thereof and the TV mount 12. The back panel 22 is preferably manufactured from hardboard or any other suitable material. A short metal plate 24 (of FIG. 3) is affixed (e.g., welded) to each of the upstanding metal support posts 10. Opposite sides of the back panel 22 are secured to the metal plates 24 by any suitable fastening means, such as screws, or the like (not shown).

As an important detail of the backlighted floor-mounted stand 1 of FIGS. 1-3, an electric light source 26 is attached to the back panel 22 so as to lie behind the shelves 7-1 and 7-2. The light source 26 is preferably a commercially-available LED light tube. However, other conventional lighting means may also be used to achieve the benefits of this invention. The light source 26 is detachably connected to back panel 22 by one or more flexible clips (designated 28 in FIG. 3) that are positioned along the back panel. The light source 26 is of sufficient size (i.e., length) to illuminate the base 3, the bottom and top shelves 7-1 and 7-2, and anything seated thereon.

A set of arcuate light-diffusing panels 30-1, 30-2 and 30-3 are coupled to the TV mount support posts 10 so as to lie in front of the back panel 22 and surround the light source 26 attached to the back panel 22. It is preferable that the light-diffusing panels 30-1, 30-2 and 30-3 be manufactured from a translucent or semi-translucent, flexible plastic material so as to hide the light source 26 from view but to enable a mood-enhancing light emitted from source 26 to illuminate the base 3 and shelves 7-1 and 7-2 of the floor mounted stand 1. The corners of the light diffusing panels 30-1, 30-2 and 30-3 are provided with wire access openings 32 for a purpose that will soon be described.

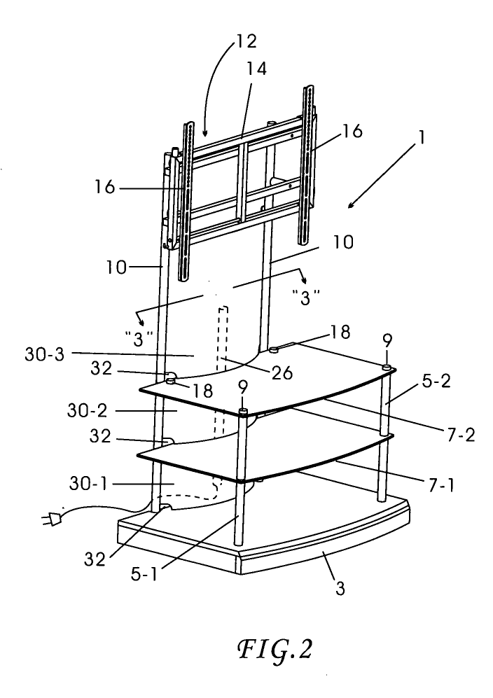

Because of their flexible nature, each of the arcuate light-diffusing panels 30-1, 30-2 and 30-3 is adapted to be bent as needed in order to be positioned behind the shelves 7-1 and 7-2 and held between the TV mount support posts 10 which extend from the base 3 upwardly to the TV mount 12. That is and as is best shown in FIG. 2, a first of the flexible light-diffusing panels 30-1 is bent around the light source 26 so as to be held in place between the support posts 10 and against the back panel 22. The first panel 30-1 is suspended between the base 3 and the bottom shelf 7-1 of stand 1. Panel 30-1 (as well as panels 30-2 and 30-3) has a spring-like memory which urges the sides of the panel into detachable engagement against the support posts 10. In this same regard, the flexible panel 30-1 (and panels 30-2 and 30-3) may also be bent to separate the panel from the support posts 10 when it is desirable to gain access to the light source 26 which, as shown in FIG. 3, lies behind the light-diffusing panels 30-1, 30-2 and 30-3.

A second of the flexible light-diffusing panels 30-2 is also bent around the light source 26 so as to be held in place by and between the support posts 10. The second panel 30-2 is suspended between the lower and upper shelves 7-1 and 7-2. The third flexible light-diffusing front panel 30-3 is likewise bent around the light source 26 so as to be held in place by and between the support posts 10. The third panel 30-3 is suspended between the upper shelf 7-2 and the TV mount 12.

FIG. 2 illustrates the assembled backlighted floor-mounted stand 1 with the flexible light-diffusing panels 30-1, 30-2 and 30-3 being held in place between and suspended by the TV mount support posts 10. Any of a variety of audio/video electronic devices can be laid upon the base 3 and/or the shelves 7-1 and 7-2. Electrical wires and cables can be interconnected to the equipment, or to the television carried by the TV mount 12, or to a source of electrical power by way of the wire access openings 32 formed in the panels 30-1, 30-2 and 30-3. Such wires and cables will remain out of sight behind the panels. The (LED) light source 26 that is mounted on the back panel 16 also remains out of sight behind the front panels 30-1, 30-2 and 30-3 and creates a relatively low, mood-enhancing decorative backlighting effect for the stand 1 that is visible through the panels and illuminates the shelves 7-1 and 7-2. Should the light no longer be desired, the power cord of the light source 26, which can also be located out of sight behind the panels 30-1 . . . 30-3, may simply be disconnected from its source of power.

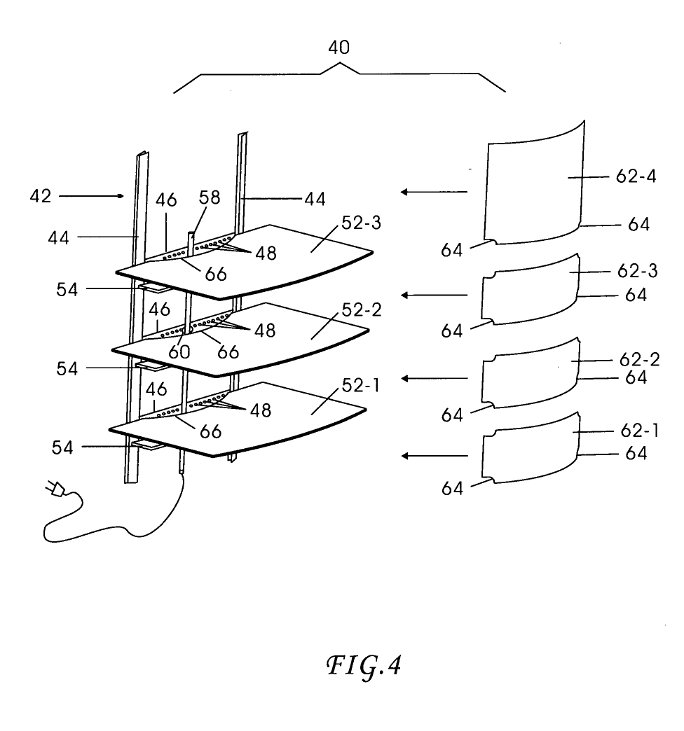

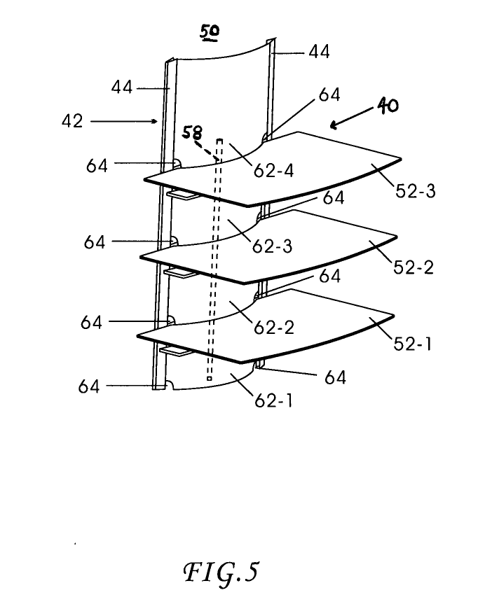

A backlighted wall-mounted stand 40 according to a second preferred embodiment of this invention is disclosed while referring concurrently to FIGS. 4 and 5 of the drawings. By way of example, the backlighted stand 40 has particular application for holding electronic audio/video equipment of the kind often used with a television and/or audio speakers. However, the items that are located on the stand are not to be considered a limitation of this embodiment. As with the floor-mounted stand 1 of FIGS. 1-3, the wall-mounted stand 40 is provided with a backlighting effect by means of a source of light that is kept at an out-of-sight location to provide both ornamental and functional benefits to the viewer.

The backlighted stand 40 includes a frame 42 having a pair of vertical side rails 44. The side rails 44 are held in spaced, parallel alignment with one another by a plurality of back braces 46 which are connected horizontally between the side rails. The side rails 44 and back braces 46 of the frame 42 of stand 40 are preferably manufactured from metal. The side rails 44 are shown having a V-shaped construction for an advantage that will soon be explained.

To this end, each of the back braces 46 which extends between the side rails 44 is provided with wall mounting holes 48. In the assembled configuration of FIG. 5, suitable fasteners (not shown) are located through the mounting holes 48 to affix the back braces 46 to a wall (designated 50 in FIG. 5), whereby the stand 40 is held against the wall and off the floor.

The wall-mounted stand 30 carries a plurality of (e.g., three) shelves 52-1, 52-2 and 52-3 that are held in spaced, parallel alignment with one another. A shelf support arm 54 projects from each side rail 44 of frame 42. The shelf support arms 54 lie below the shelves 52-1, 52-2 and 52-3 to provide lifting supports for holding the shelves in place in front of the side rails 44.

As an important detail of the backlighted wall-mounted stand 40 of FIGS. 4 and 5, an electric light source 58 is attached to the back braces 46 so as to lie behind the shelves 52-1, 52-2 and 52-3. Like that earlier described, the light source 58 is preferably a commercially-available LED light tube. The light source 58 is detachably connected to one or more of the back braces 46 by flexible clips (designated 60 in FIG. 4) carried by the back braces. The light source 58 is of sufficient size (i.e., length) to illuminate each of the shelves 52-1, 52-2 and 52-3.

A corresponding set of (e.g., four) arcuate light-diffusing panels 62-1, 62-2, 62-3 and 62-4 are coupled to the frame 42 at the side rails 44 so as to lie in front of the back braces 48 and surround the light source 58 coupled to the back braces. It is preferable that light-diffusing panels 62-1 . . . 62-4 be manufactured from a translucent or semi-translucent, flexible plastic material so as to hide the light source 58 from view but to enable a mood-enhancing light emitted from the source 58 to be visible through the panels. The corners of the light-diffusing panels 62-1 . . . 62-4 are provided with wire access openings 64.

Because of their flexible nature, each of the arcuate light-diffusing panels 62-1 . . . 62-4 is adapted to be bent as needed in order to be positioned behind the shelves 52-1, 52-2 and 52-3 and between the V-shaped side rails 44 of the frame 42 of stand 40. To form a snug fit, each shelf 52-1, 52-2 and 52-3 is provided with an inwardly curved rear edge 66 (best shown in FIG. 4). To this end, and as is best shown in FIG. 5, a first one 62-1 of the flexible light-diffusing panels is bent around the light source 58 so as to be received within the curved rear edge 66 of the first shelf 52-1. Opposite sides of the panel 62-1 are located within and retained by respective ones of the V-shaped side rails 44. Thus, the panel 62-1 will be held in place between side rails 44 and suspended between the floor and the bottom shelf 52-1 of stand 40.

The flexible panel 62-1 has a spring memory which urges the sides of the panel into detachable engagement with the pair of V-shaped side rails 44. In this same regard, the flexible panel 62-1 may also be bent when necessary to separate the panel from the side rails 44 in order to gain access to the light source 58 which lies behind the light-diffusing panels 62-1 . . . 62-4.

The remaining flexible light-diffusing panels 62-2, 62-3 and 62-4 are bent around the light source 58 and detachably connected to and retained by the pair of side rails 44 so as to be suspended therefrom in the same manner described while referring to the light panel 62-1. Thus, as is best shown in FIG. 5, the light panel 62-2 will be suspended from side rails 44 to lie above shelf 52-1, the light panel 62-3 will lie above shelf 52-2, and the light panel 62-4 will lie above shelf 52-3. In the assembled configuration of FIG. 5, the light panels 62-1 . . . 62-4 are axially aligned one above the other so as to fill in the space between the pair of side rails 44 and keep the light source 58 out of sight.

As previously explained, any of a variety of audio/video electronic equipment can be laid upon one or more of the shelves 52-1, 52-2 and 52-3 of the backlighted wall-mounted stand 40. The electrical power cord 68 from the light source 58 and the electrical wires and cables from the audio/video equipment can be routed as needed or connected to a source of electrical power by way of the wire access opening 64 formed in the shelves 52-1, 52-2 and 52-3. Such wires and cables will remain out of sight behind the panels 62-1 . . . 62-4. The (LED) light source 58 that is attached to the back braces 46 also remains out of sight behind the panels and creates a relatively low, mood-enhancing decorative backlighting effect for the stand 40 while illuminating the shelves 52-1, 52-2 and 52-3.

1. A stand comprising:
a base to sit on the floor;
at least first and second supports extending upwardly from said base;
at least one shelf being supported by said first and second supports at a location above said base;
a first light transparent panel coupled to said first and second supports such that said shelf is located in front of said panel; and
a light source located behind said light transparent panel, said light source being illuminated to create a backlighting effect for said stand that is visible through said panel.

2. The stand recited in claim 1, further comprising a TV mount connected to said first and second supports at a location above said shelf, said TV mount adapted to be connected to a television.

3. The stand recited in claim 1, further comprising a back panel connected between said first and second supports, said light source being held by said back panel behind said light transparent panel.

4. The stand recited in claim 3, wherein said light transparent panel is detachably connected to said first and second supports so as to extend between said supports in front of said back panel.

5. The stand recited in claim 4, wherein said light source is positioned between said light transparent panel and said back panel.

6. The stand recited in claim 1, wherein said light transparent panel has a wire access opening formed therethrough and adapted to receive an electrical wire from an electronic device seated on said shelf.

7. The stand recited in claim 1, wherein said light source is an electrically-powered LED tube.

8. The stand recited in claim 1, wherein said light transparent panel is flexible so as to be bent around said light source.

9. The stand recited in claim 8, wherein said flexible light transparent panel has a spring memory for urging said panel into detachable engagement with said first and second supports when said panel is bent around said light source.

10. The stand recited in claim 1, further comprising a second light transparent panel coupled to said first and second supports such that said shelf is located in front of said second panel and said light source is located behind said second panel, said first and second light transparent panels being detachably connected to said first and second supports and disposed one above the other.

11. A stand comprising:
first and second vertical supports;
a back brace extending horizontally between said first and second supports, said back brace adapted to be connected to a wall;
at least one shelf being supported by said first and second supports;
a first light transparent panel coupled to said first and second vertical supports such that said shelf is located in front of said panel; and
a light source located behind said light transparent panel, said light source being illuminated to create a backlighting effect for said stand that is visible through said panel.

12. The stand recited in claim 11, wherein said light source is held by said back brace behind said light transparent panel.

13. The stand recited in claim 11, wherein each of said first and second vertical supports is a V-shaped rail, said light transparent panel being attached to and retained by said V-shaped rails so as to extend between said rails in front of said light source.

14. The stand recited in claim 11, wherein said light source is positioned between said light transparent panel and said back brace.

15. The stand recited in claim 11, wherein said light transparent panel has a wire access opening formed therethrough and adapted to receive an electrical wire from an electronic device seated on said shelf.

16. The stand recited in claim 11, wherein said light source is an electrically-powered LED tube.

17. The stand recited in claim 11, wherein said light transparent panel is flexible so as to be bent around said light source.

18. The stand recited in claim 17, wherein said flexible light transparent panel has a spring memory for urging said panel into detachable engagement with said first and second vertical supports when said panel is bent around said light source.

19. The stand recited in claim 17, wherein said shelf has a inwardly curved rear edge, said flexible light transparent panel being received against said curved rear edge when said panel is bent around said light source.

20. The stand recited in claim 11, further comprising a second light transparent panel coupled to said first and second vertical supports such that said shelf is located in front of said second panel and said light source is located behind said second panel, said first and second light transparent panels being detachably connected to said first and second vertical supports and disposed one above the other.
